(19) United States
(12) Patent Application Publication
(10) Pub. No.: US 2018/0019886 A1
(43) Pub. Date: Jan. 18, 2018

(54) METHOD AND SYSTEM FOR MANAGING COMMUNICATION SERVICES USE OF A MOBILE COMMUNICATIONS UNIT

(71) Applicant: GLOBETOUCH AB, Stockholm (SE)

(72) Inventor: Bjorn KNUDSEN, Hasselby (SE)

(73) Assignee: GLOBETOUCH AB, Stockholm (SE)

(21) Appl. No.: 15/534,598

(22) PCT Filed: Dec. 14, 2015
(86) PCT No.: PCT/SE2015/051333

§ 371 Date: Jun. 9, 2017

(30) Foreign Application Priority Data
Dec. 15, 2014 (SE) 1451544-9

(51) Int. Cl. H04L 12/14; H04W 4/24; H04M 15/00; H04W 8/18

(52) U.S. Cl. CPC H04L 12/1403; H04W 4/24; H04M 15/60; H04M 15/8235; H04W 8/183

(57) ABSTRACT

Disclosed is a method for managing the use by a wireless communications unit including a SIM card of wireless communications routed via a gateway node, a charging server and a BSS, which gateway node categorizes communication services into a set of access types. The BSS provides a digital communications interface, accepting requests from third parties regarding the access to services of specific types to the user, a session is initiated between the unit and the gateway, pertaining to a certain access type, the gateway queries the charging server and the BSS regarding the availability of the certain access type, the BSS provides to the charging server and the gateway such information based upon the requests, the gateway provides access to the service, and the gateway provides information to the charging server and the BSS regarding service usage.

The present invention relates to a method and a system for managing communication services use of a mobile communications unit. Specifically, the invention relates to the use of such a mobile communications unit in a mobile communications network, such as a GSM, GPRS, 3G or 4G network, or the like, requiring a SIM (Subscriber Identity Module) card in the mobile unit, and possibly in addition in a WiFi network or similar wireless network, not requiring a SIM card.

Preferably, the communication services are mobile data access services, as opposed to voice communication services.

Communications to and from a mobile communication device are conventionally routed via a serving node, such as an SGSN (Serving GPRS Support Node) for a GPRS network and an SGW (Serving GateWay) for an LTE network, in communication with a gateway node, such as a GGSN (Gateway GPRS Support Node) for a GPRS network and a PGW (Packet Data Network GateWay) for an LTE network. The gateway node is typically connected to an OCS (Online Charging System) or an RTS (Realtime Charging System). In the following, OCS:s and RTS:s will interchangeably be referred to as “charging servers”. CDR:s (Charging Data Records) are typically produced by the gateway node and communicated to the charging server for subsequent processing, such as invoicing. The charging server can also hold information regarding allowed data quotas and the like.

Typically, a BSS (Business Support System) is used for handling of the user account data. Such a BSS communicates with the charging server.

Such a method and system is described in the Swedish patent application no. 1450533-1, which has not yet been published at the filing date of this application.

Today, mobile access to a high speed internet connection is becoming increasingly important for many categories of users of mobile devices, such as business users, private users, roaming users, etc. It is also becoming increasingly common for individual persons to use one and the same mobile device for both business and leisure purposes, both when home and when roaming abroad. Then, it is often difficult to keep apart work-related use and private use. For instance, the employer typically wants an employee to have access to high speed internet, while not allowing the employee to misuse such access for private purposes. Mobile phones having dual SIM card holders have been proposed to address this issue. However, they are many times complicated to use.

At the same time, many suppliers of online content need their users to have high quality internet access in order to be able to purchase offered content.

The present invention addresses these issues by providing a method and a system providing a way to allow users access to a stable internet connection, while allowing both the user, an employer and third parties the possibility to guarantee the provision of mobile internet access to a mobile device of the user such that the interests of each such party can be taken care of in various circumstances.

Thus, the invention relates to a method for managing the use by a particular user of wireless communication services, which user uses a wireless communications unit comprising a SIM (Subscriber Identity Module) card used for identification of the unit, wherein wireless communications to and from the wireless communications unit are routed via a gateway node, which communicates with a charging server, in turn communicating with a BSS (Business Support System), which gateway node categorizes different wireless communication services into a set of access types, characterized in that the method comprises the steps of a) the BSS providing a digital communications interface arranged to accept requests from third parties regarding the granting of access to wireless communication services of specific types to the user; b) initiating a wireless communication session between the wireless communications unit and the gateway node, pertaining to a certain one of said access types; c) the gateway node querying the charging server, and the charging server querying the BSS, regarding the availability of communication services of the certain access type for the user of the wireless communication device; d) the BSS providing to the charging server, and the charging server to the gateway node, information regarding applicable limitations of the provision of such communication services to the user based upon one or several of said requests; e) the gateway node providing to the user access to such communication services in case they are available; and f) the gateway node providing information to the charging server, and the charging server to the BSS, regarding usage of communication services of the certain access type.

Further, the present invention relates to a system.

In the following, the invention will be described in detail, with reference to the appended drawings, where:

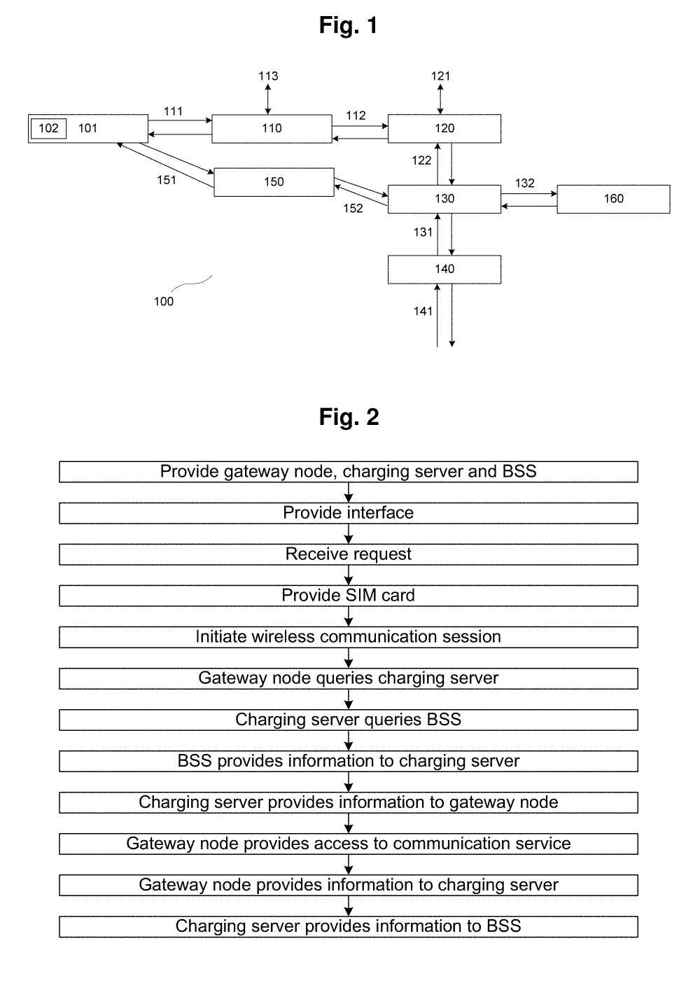

FIG. 1 is a simplified overview diagram of a system according to the present invention for use in a method according to the present invention;

FIG. 2 is a flow chart of a method according to the present invention;

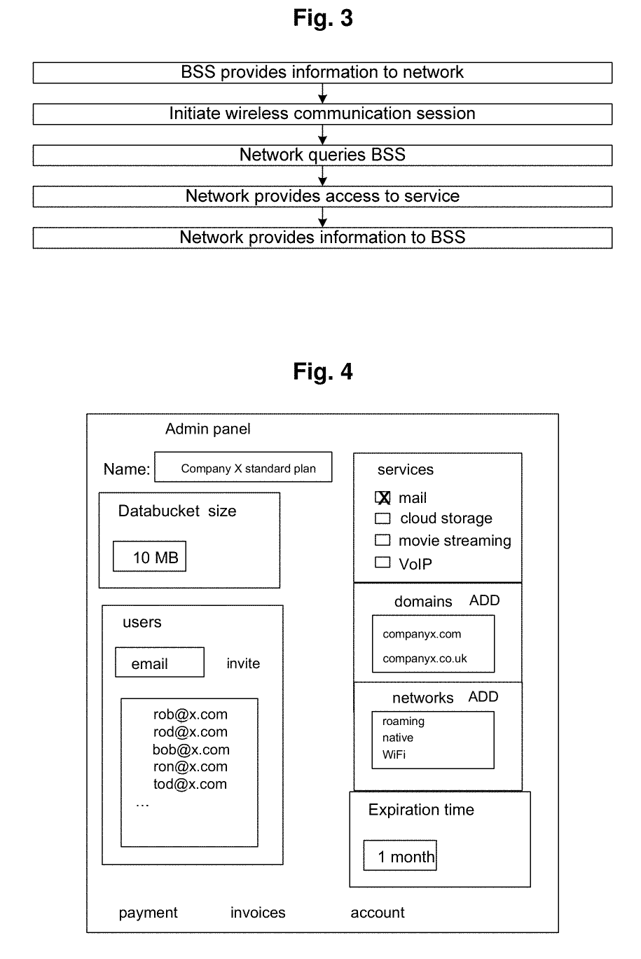

FIG. 3 is a flow chart of an additional aspect of the method according to the present invention; and

FIG. 4 illustrates an interactive user web interface according to the invention.

Hence, FIG. 1 shows a system 100 for managing the use by a particular user of wireless communication services. The user uses a wireless communications unit 101 for accessing such wireless communication services of various types, such as is described in detail below. The unit comprises a SIM (Subscriber Identity Module) card 102 used for identification of the unit 101 to the network to which the unit 101 is connected, and possibly also to the system 100. The unit 101 may be a mobile telephone, a PDA, a laptop or any other mobile communications unit arranged to allow a user to access wireless communications services using the unit 101.

The system 100 may comprise, or be, or comprise component parts that are as such parts of, a telecommunication network, such as a 2G, 3G or LTE network, or any other type of network requiring each connected device to use a SIM card for identification. Wireless communications 111 to and from the wireless communications unit 101 are routed via a gateway node 110, which is preferably a part of such a telecommunication network, and may be a GGSN, PGW or similar. Hence, the gateway node 110 is arranged to provide wireless communications 111 to and from the wireless unit 101. In other words, the wireless communication 111 terminates at the gateway 110.

The gateway node 110 is arranged to communicate 112 with a charging server 120 in the form of an OCS or an RTS, which in turn communicates 122 with a BSS 130.

Furthermore, the gateway node 110 is arranged to categorize different wireless communication services into a set of access types for managing data communication usage. Preferably, the gateway node 110 is arranged to automatically detect at least one access type for each requested communication session with a particular unit, such as unit 101, and to afterwards report a quantity, such as data amount or duration, of a session, to the charging server 120. Typically, the gateway node 110 is remotely configurable, using an externally available, preferably web-based, administration interface (not shown in the figures), using which an administrator of the system 100 may define what access types that the gateway node should distinguish, specific actions to be taken by the gateway node 110 in relation to particular access types, and the like. The charging server 120 preferably has a similar interface for remote configuration of handled access types and behavior.

Herein, the expression “access type”, in the context of a particular wireless communication service, means a specific characterization of the connection or mode of communication used when accessing the communication service in question. For instance, such access types may comprise communications using a particular specified port, such as port 80 for HTTP (HyperText Transfer Protocol); communications pertaining to a particular specified domain or URL (Uniform Resource Locator), such as www.foggmobile.com; streaming communications, such as streamed video content; communications over a particular specified protocol, such as FTP (File Transfer Protocol), or communications to and from a roaming unit in any or a particular roaming network which is different from the network to which the gateway node 110 belongs. “Access types” are sometimes called “rating groups”. A particular session may pertain to more than one access type.

The BSS 130 is arranged with or in communication 131 with a digital communications interface 140, which is arranged to allow parties, such as the user of the unit 101, administrators of the system 100 and/or third parties, to view and possibly also edit 141 various information pertaining to individual users, user groups and communication service access, which information is used and produced by the BSS 130 during the operation of the system 100 serving users, via wireless communication units such as unit 101, with wireless communication services. Preferably, the digital communications interface 140 is an interactive web interface provided by a web server.

The system 100 comprises the gateway node 110, the charging server 120, the BSS 130 and the interface 140.

FIG. 2 illustrates a method according to the invention, using a system such as system 100.

In a first step, the gateway node 110, the charging server 120 and the BSS 130 are provided.

In a second step, the digital communications interface 140 is provided, for instance by the BSS 130, which interface is arranged to accept requests from third parties regarding the granting of access to wireless communication services of specific types to the user of the wireless unit 101. The interface 140 is also set up so that the information provided by third parties is accessible from the interface 140 by the BSS 130.

Such a request regarding the granting of access may, for instance, be an employer of the user granting access to general internet usage with a particular highest bitrate, say 10 Mbit/s, for up to 5 GB of data traffic, and up to 1000 minutes of non-roaming voice communications; or a certain amount of general internet access including up to 1 GB of VoIP (Voice over IP). It may furthermore be the user requesting access to general internet access with particular restrictions; a third party provider of a certain streaming video or audio service granting the user unlimited access to high-speed streaming connectivity services from the particular domain of the provider in question; or a third party provider of internet content such as a news service, granting the user internet access of up to 1 GB directed to and from the relevant URL:s (Uniform Resource Locator) where the news service can be accessed. All such requests may comprise an expiration time limit, such as one month from the time of the request; and/or a maximum bitrate and/or total data transfer per time unit, such as expressed in Mb/s, Mb/day, minutes/week or the like. It is preferred that the requesting party is required to either provide payment (or a line of credit, or similar) covering the requested access. The actual connectivity for providing the communication services is provided by the system 100 via the gateway node 110.

It is preferred that each such access grant, in terms of one or several types of communication services and related limitations, can be mapped to one or several access types that can be interpreted by the gateway node 110. This mapping can be performed by the BSS 130, the charging server 120 or the gateway 110, preferably by the BSS 130 in combination with the charging server 120, more preferably by the BSS 130.

In a third step, at least one request of the above described type is received from a third party or the user.

In a fourth step, which may be performed ahead of time, the SIM card 102 is provided to and installed in the wireless unit 101, identifying the unit 101 to the telecommunications network, and in particular to the gateway node 110, via an IMSI (International Mobile Subscriber Identity) and/or an MSISDN in a way which is conventional as such. It is preferred that the SIM card 102 is supplied to the user of the unit 101 by the operator of the system 100, or at least that the SIM card 102 is associated with the system 100 in such a way so that wireless communications with the unit 101 will terminate in the gateway node 110, and so that the gateway node 110 can limit access to wireless communication services for the unit 101 being identified using the SIM card 102, when the unit 101 initiates a wireless communication session via the gateway node 110.

Then, in a fifth step, such a wireless communication session 111 is initiated between the wireless communications unit 101 and the gateway node 110, pertaining to a certain one of the access types interpretable by the gateway node 110.

As a result, in a sixth step, the gateway node 110 automatically queries the charging server 120 regarding the availability of wireless communication services of the said access type for the user in question of the wireless communication unit 101, which access type is determined by the gateway node 110 based upon information pertaining to the said communication session as such.

It may be so that the charging server 120 already comprises cached information regarding the availability of such communication services from a previous access request from the unit 101, see below. If this is not the case, then, in a seventh step, performed in reaction to the sixth step, the charging server 120 queries the BSS 130 regarding the availability of the said communication services of the said certain access type for the user of the wireless communication unit 101.

In an eighth step, performed in reaction to the seventh step, the BSS 130 provides to the charging server 120 information regarding applicable limitations of the provision of such communication services to the user, using the unit 101 and based upon one or several of requests made previously using the interface 140. Such limitations may, for instance, be formulated in terms of maximum quantity, such as minutes of voice traffic or MB of data; maximum bitrate, such as Mb/s; maximum quantity per time unit, such as Mb/day; an expiration time, such as a latest date at which services of the access type in question can be used; and/or other similar criteria. The applicable limitation for a particular communication type may also be, for instance, “unlimited” or “never available”.

In case a particular session pertains to more than one access type, it is preferred that the session is allowed as long as at least one applicable access type is available for the particular user.

In general, a particular communication type is preferably associated with a particular maximum limit in terms of data quantity, session time and/or data bandwidth, and the applicable limitations are preferably communicated from the BSS 130 to the gateway node 110, via the charging server 120, comprising such a maximum limit for the communication type in question.

If no requests were made via the interface 140 before the fifth step, the BSS 130 may respond using a particular default availability, such as availability of general internet and/or voice communications. Such default availability may be associated with particular conditions of a mobile subscription of the user, and usage of wireless communication services falling under such availability is preferably billed directly to the user (see below).

Then, in a ninth step, the charging server 120 provides information to the gateway node 110 regarding applicable limitations of the provision of the wireless communication services associated with said communication session. These limitations may be formulated in terms of the same access type definitions in both the gateway node 110 and the charging server 120. Alternatively, the charging server 120 may implement a business logic layer on top of the gateway node 110, so that it receives limitation information from the BSS based upon a first, more complex, division of different types of wireless communication services; translates this information so that it maps into a second, more concrete division of different such service types; and communicates the limitation information in terms of the second division.

For instance, the BSS 130 may provide information to the charging server 120 that the user in question may be granted access only to sessions involving URL:s comprising the word “foggmobile” (first division), and the charging server 110 may then translate this information into “access granted to www.foggmobile.com” (second division) for a particular initiated session.

In general, the gateway node 110 maps sessions to individual access types, whereas the BSS 130 allows parties to request access grants in terms of “wireless communication service types”. Each wireless communication service type, as the term is used herein, can be mapped onto one or several “access types”. Typically, a “wireless communication service” will have a more complex definition than an “access type”. The system 100 preferably comprises a two-way mapping function between access types and communication types, preferably implemented either in the charging server 120 or the BSS 130.

In a tenth step, the gateway node 110 then provides access to the user, via the unit 101, access to the said communication services, but only in case they are available according to the limitation information received from the charging server 120 for the access type in question. In other words, the gateway node 110 then allows the session to initiate and wireless communications to start and proceed.

In an eleventh step, the gateway node 110 provides information to the charging server 120 regarding usage of communication services of the certain access type. Such information may for instance be provided continuously during the lifespan of the session, or after or in connection to the closing of the session.

The gateway node 110 preferably communicates 112 with the charging server 120 via a digital communications interface, preferably a bidirectional interface, most preferably a diameter interface. It is furthermore preferred that the gateway node 110 continuously delivers information to the charging server 120 regarding used number of data chunks of a given size for the session in question.

In a twelfth step, the charging server 120 provides such usage information to the BSS 130, preferably continuously but possibly after or in connection to the closing of the session in question. At this point, the access type of the session may be translated into a corresponding communication service type, as described above.

In reaction to the provision of information to the BSS 130 from the charging server 120, the BSS 130 is preferably arranged to update the current maximum limit for the type of communication services in question, as applicable.

The gateway node 110, the charging server 120 and/or the BSS 130 may monitor the progress of the communication session, possibly on different levels. For instance, the gateway node 110 may continuously monitor and limit instantaneous bitrate, if there is such a limitation for the current session, while the charging server 120 or, preferably, the BSS 130 monitors and restricts total usage, across multiple sessions, during a particular time period, such as a particular month, in case such a limitation exists. This depends upon the detailed configuration of the system 100 and of the purposes to be achieved. For instance, the gateway node 110 may automatically close down a particular session once a maximum total data amount has been reached.

Hence, third parties may use the interface 140 for specifying, in the form of the above discussed requests, access grants for particular users to particular types of wireless communication services. Then, these high-level access grants are automatically translated into more low-level information interpretable by and provided to the gateway node 110, which in turn uses acceptance, refusal and control of individual sessions to make sure that the limitations of each access grant is met. Usage information is fed in the other direction, from the gateway node 110 to the charging server 120 and the BSS 130.

As a result, any party, comprising the employer of the user, the user him- or herself as well as any third party having an interest in providing the user with access to specific wireless communication services under particular conditions, may use the interface 140 to specify access grants, which are then automatically and immediately implemented when the user uses the unit 101. Preferably, the interface 140 also permits monitoring, particularly in case a continuous information feed is present as described above from the gateway node 110, via the charging server 120 and to the BSS 140, the continuously updated status progress of each access grant by the party having placed the corresponding request, and preferably always by the user. Furthermore, the interface 140 is preferably arranged to allow a requesting party to manage, such as updating, changing or cancelling, requested access grants. The communication between the interface 140 and the BSS 130, in case the interface 140 is provided by a standalone web server or the like, can take place over conventional secure protocols, such as over the internet.

The charging server 120, as used in the context of the present invention, solves the problem that the gateway node 110 is in general not arranged to participate in a realtime or near realtime communication with the BSS 130.

FIG. 1 also shows a billing function 160, such as provided by a financial institution, arranged to receive billing instructions 132 from the BSS 130 regarding pre- or postpayment of consumed communication services. It is preferred that any requesting party is automatically billed, in advance or after the consumption by the user, via unit 101, of each such service, for any services allowed as a consequence of a request made via the interface 140 by the requestor in question.

In order to effectuate such payment, it is preferred that the BSS 130 stores historic information regarding to what party's request or default access right each session pertains, and that the BSS 130 makes available, to the billing function 160, information based upon this historic information for billing purposes. The information about each requesting party may be gathered in a way which is conventional as such, for instance in connection to registering of the requesting party with the interface 140.

According to a preferred embodiment, several gateway nodes 110 are used, possibly together with one and the same charging server 120 or using their own respective charging server 120. In this case, the information regarding access grants and usage information is shared between the gateway nodes, for instance coordinated by the BSS, which is preferably one and the same for each gateway node comprised in the system 100.

It is preferred, as mentioned above, that the gateway node 110, or said gateway nodes, cache the above discussed availability information. As a supplement or alternative, the charging server 120, or charging servers, may also cache said availability information. Hence, in the latter case, upon the initiation of a wireless communication session between the wireless communications unit 101 and the gateway node 110, or another gateway node which is connected to the charging server 120, which session pertains to a certain access type as determined by the gateway node 110, and upon a query from the gateway node 110 in question to the charging server 120 regarding the availability of communication services of the access type in question, the charging server 120 is preferably arranged to check whether information regarding availability of communication services of the access type in question is already present in the charging sever 120, and if such is the case, respond to the gateway node 110 in question directly, instead of querying the BSS 130 regarding the availability of the said access type. As described above, the charging server 120 may determine if this is the case in terms of a communication service type corresponding to the access type in question. The corresponding can also be done directly in the gateway node 110, then in terms of the access type directly, so that no query is sent to the charging server 120 in case updated availability information is already present in the gateway node 110 regarding the access type of the session in question.

According to a preferred embodiment, a particular type of communication service is associated with a particular condition under which such communication services are to be available to the user. Such information is preferably specified as part of the above discussed requests via interface 140. Examples of such conditions comprise that access to a particular type of service is only available during weekdays and office hours, or only later than a particular time at night. Other examples comprise restricted access only when roaming in specified roaming networks, or only when not roaming; and such. In case such limitations are specified in the request, they are automatically mapped onto applicable limitations communicated from the BSS 130 to the gateway node 110, via the charging server 120, so that the availability limitation information comprises information regarding said particular condition, after which the gateway node 110 can use this information when determining whether to allow a particular session to proceed or not. The charging server 120 can also perform this analysis. Alternatively, the BSS 130 is arranged to determine the said applicable limitations based upon a currently prevailing condition at the time of the receipt by the BSS 130 from the charging sever 120 of the query in the above described seventh step, which condition is compared by the BSS 130 to the particular condition to be applied, before communicating the applicable limitation information to the charging server 120 in the eighth step. The corresponding can also be true regarding the charging server 120 instead of the BSS 130.

It is preferred that the digital communications interface 140 is arranged to accept specifications of particular maximum limits and/or particular conditions, as exemplified above, for the granting of access to said specific wireless communication services to particular users. The interface is preferably auto populated with all available types of communication services, respective maximum limits, conditions, and preferably all users, to be selected by the party making the request. This information is preferably stored in a database comprised in or accessible by the BBS 130, from where it is made available to the interface 140. Different requesting parties and different users can have different sets of controllable parameters. Preferably, requesting parties log into the interface, in a way which is conventional as such, whereupon the appropriate parameters are presented to the party in question, such as in an interactive web interface. For parties such as employers and content providers, user groups can be identified, and requests can be made for such user groups, resulting in that availability information is defined for each individual user in such group.

Preferably, the interface 140 is also arranged to present, preferably continuously updated, usage information to the user.

According to a particularly preferred embodiment, in case a particular session is initiated by a particular wireless communication unit, which session is of a certain access type that maps onto several requests, possibly made by different parties, requests are prioritized between parties according to a predetermined prioritization schedule. For instance, both an employer and an employee may have requested, paid for or provided a line of payment for, general internet access using the interface 140. When the user browses the web using the unit 101, both these requests result in the availability of general internet access, why the browsing session will be allowed by the gateway 110 after querying the charging server 120. However, in order to decide which request to adjust the used volume for, the BSS, after receiving the usage information from the gateway node 110, via the charging server 120, records the usage as pertaining to the prioritized party's request.

According to a preferred embodiment, third parties in the form of content providers paying for the provision of, for instance, internet access in order for a user to be able to consume communication services provided by the content provider in question are prioritized before a party, such as an employer of the user, paying for internet connectivity for business use, which in turn is prioritized before requests made by the user him- or herself. Then, the limitations communicated from the BSS before allowing a certain session are updated to reflect the availability of the prioritized request in question. Hence, it may be so that a quota pertaining to a particular request is first used up, after which the session is closed, and that another session of the same access type must be opened, and mapped to a less prioritized request, for continuing the service consumption by the unit 101.

It is preferred that each user is associated with a general subscription with the system 100 operator, automatically providing a default internet connectivity request which is prioritized as the last resort in the said priority schedule, so that a connection is always available even if no party has actually made a request covering the particular access type for the session in question. It is preferred that the user is billed for such default connectivity.

Hence, in this case the BSS 130 associates the user with a default access grant to wireless communications. In case no request has been accepted by the BSS 130 covering the access type of a requested communication session, the information provided by the BSS 130 to the charging server 120 comprises limitations associated with the said default access grant.

Each one of said type of wireless communication service types can comprise several different of said access types; and/or several identical of said access types but associated with different conditions and/or maximum limits.

The above described priority schedule guarantees that communication service usage is automatically billed to a predetermined interesting party, so the connectivity ordered by prioritized parties is automatically used up before connectivity ordered by less prioritized parties is used.

According to a preferred embodiment, the BSS 130 is arranged to make available predetermined packages of wireless communication service types, with associated predetermined conditions and/or maximum limits according to the above, to which packages a single one of said requests can collectively pertain. Hence, an operator of the system 100 may, for instance, define a package as a certain set of service types, with corresponding limitations and conditions, such as “100 MB of general internet usage and 100 minutes of telephone call time for use when roaming within Europe and during the coming month”, which package can then be directly selected by a third party for automatic provision to a certain particular user.

In FIG. 1, a wireless network 150, such as a WLAN network, is also shown. The network 150 is arranged to provide a wireless internet connection 151 to the unit 101, and is a different, separate network from the one, preferably comprising the gateway 110, to which the unit identifies using the SIM card 102. Such internet connection 151 does not require the SIM card 102 for identification of the unit 101. Instead, identification of the unit 101 to the network 150 preferably takes place via a conventional wireless authentication method, such as a username/password pair provided according to a WEP (Wired Equivalent Privacy) authentication method, or in any other conventional way.

The BSS 130 is also arranged to communicate 152 with the network 150, such as via the internet.

According to a preferred embodiment, the above described requests can hence pertain to wireless communication services provided not via the gateway node 110 but using the wireless communications network 150, such as using WLAN connectivity. In other words, one or several of the communication types may be performed using connectivity via the network 150.

In this preferred embodiment, the method further comprises the additional steps shown in FIG. 3. These steps can be performed after the third step of FIG. 2, performed after the provision of at least one request according to the above, which request pertains to at least one communication service type to be provided, as specified in the request, via the network 150.

In a first step according to FIG. 3, the BSS 130 thus provides to the separate network 150 information regarding applicable limitations, if any, of the provision of communication services to the user of the wireless communications unit 101, based upon one or several of the said requests.

Then, in a second step, a wireless communication session is initiated between the unit 101 and the network 150. This may, for instance, take place by the unit 101 logging into the network 150 using the above said username/password combination and requesting some type of communication service, such as internet connection or a VoIP call.

In a third step, the network 150 queries the BSS 130 regarding the availability of the particular type of communication service to which the session initiated with the unit 101 pertains. This step can be similar to steps six-nine of FIG. 2, but instead of the gateway node 110 querying, via the charging server 120, the BSS 130 for availability information, it is the network 150 that queries the BSS 130 for this information. The network 150 may, as is the case for the gateway node 110, have a set of access types that are different, such as more low-level, than the communication types used by the BSS 130.

In a fourth step, the network 150 provides to the user, via the unit 101, access to such communication services, in case they are available. This step is hence similar to step ten of FIG. 2.

Then, in a fifth step which is similar to steps eleven and twelve of FIG. 2, the wireless network 150 provides information to the BSS 130 regarding usage of said wireless communication services.

This way, a user of the method can gain access to wireless communication services via not only the gateway 110 but also via one or several non-cellular wireless networks 150, such as WiFi hotspots operated by a WiFi operator collaborating with the operator of the system 100. This can take place in a way which is completely transparent to the user of the unit 101, in the sense that the user does not have to care about whether the communication services are provided via the cellular network or via a WLAN network 150. An initial step may be needed, depending on the circumstances and the functionality offered by the unit 101, in which the user instructs the unit 101 to prioritize WLAN connectivity when available and/or enters any needed credentials for wirelessly logging into the network 150, such as the above described username/password pair, to the unit 101. Then, when the unit 101 is within the coverage area of the network 150 and the user initiates the use of a particular wireless communication service, the unit 101 will first attempt to initiate a corresponding session via the network 150. The network 150 will then query the BSS 130 about the availability of the service type in question. The BSS 130, in turn, can then respond to this query depending on if any party has requested the service in question to be delivered via the network 150, any applicable limitations or conditions specified in such request, and any prioritization involving the network 150 in relation to connectivity via the gateway node 110.

Hence, the BSS 130 can apply prioritization involving both the network 150 and the gateway 110 by denying access to services via the network 150 in case the gateway 110 is prioritized over the network 150 for some reason. In this case, the BSS 130 performs the said prioritization between the gateway node 110 and the wireless network 150, so that a wireless communication service of a particular type is provided to the user either via network 150 or gateway node 110 depending on a predetermined criterion.

According to the invention, the unit 101 is always equipped with a SIM card 102, and capable of communicating with the gateway 110, in turn being connected to the BSS 130 via the charging server 120. Hence, a connection only to the network 150 and not to the gateway node 110 is not within the scope of this invention.

In the following, the invention will be further exemplified.

FIG. 4 shows an exemplifying interactive web interface as provided by 140, which in this example comprises or constitutes a web server connected to or comprised in the BSS 130. A logged in user “Company X” can select a “standard plan”, involving prefilled fields as illustrated in FIG. 4, for a number of users as illustrated under the field “users”. Various things can be interactively modified, such as maximum amount of data (“Databucket size”); communication services types (“services”), domains, networks (for instance gateway node 110 or WiFi network 150, but also roaming partner networks, as long as the communications terminate in a gateway node which is connected to BSS 130), and expiration time of the access grant. Via the interface, the user can also administrate payment and invoicing regarding requested access grants and their corresponding usage, as well as changing personal data and preferences (“account”).

It is realized that such an interface 140 may be designed in many ways, and comprise various more or less complex options.

In a specific example, a particular mobile user has a corporate data plan that allows the use of a particular cloud-based mail service with up to 1 GB per month. The user also has 5 hours of free usage of a particular streaming movie service from a particular provider using a particular web address. These access rights have been requested by the user's employer, using interface 140, for the user in question. The user has also purchased, by logging into the interface and making the corresponding request for him- or herself, 2 GB of private general internet data traffic with no particular time limit.

So when the user sets out to use the said mail service using his or her smartphone, a data session is initiated. The GGSN to which the smartphone is connected identifies the session as the particular mail service, RGA). The GGSN then asks the OCS to which it is connected for access, and the OCS in turn asks the BSS to which it is connected what data plans this user has. The BSS responds: 1 GB RGA, 5 hours of RGB and 2 GB RGC.

The OCS responds back to the GGSN: Grant access with 10 MB. The user is then spending data on the mail service, on the employer's expense.

At the end of the session, the GGSN reports back the OCS the consumption, and the OCS reports the consumption further to the BSS. The total consumption during this session was 45 MB, and the maximum amount RGA is therefore adjusted down to 0.955 GB.

As the user uses the smartphone to set up a new data session to watch streaming video provided by the said provider, the GGSN identifies the traffic as RGB), the GGSN asks the OCS for access, the OCS asks the BSS what data plans this user has and the BSS responds: 0.955 RGA, 5 hours RGB and 2 GB RGC. Hence, the OCS responds back: Grant access with 5 hours. At the end of the session, the GGSN and the OCS report back the consumption to the BSS. The consumption was 45 minutes, so the maximum limit was adjusted down to 4 hours 15 minutes.

So when the user in FIG. 1 sets up a new data session to a certain web address, the GGSN identifies the traffic as RGC), the GGSN asks the OCS for access, the OCS asks the BSS what data plans this user has, and the BSS responds: 0.955 GB RGA, 4 hours 15 minutes RGB and 2 GB RGC. The OCS responds back: Grant access with 2 GB. At the end of the session, the GGSN and the OCS report back the consumption to the BSS, and the RGC maximum limit is adjusted down accordingly.

Situations in which particular conditions (such as time of day), prioritizations and concurrent access to a WiFi network are treated in analogous ways and as described above.

Above, preferred embodiments have been described. However, it is apparent to the skilled person that many modifications may be made to the described embodiments without departing from the basic thought of the invention.

For instance, a method according to the present invention can be used with other wireless networks than a 2G, 3G, LTE or WLAN network, using the corresponding principles.

Also, a particular user may have several wireless communication units. In this case, all registered units for a particular user account in the BSS are preferably grouped, so that consumption via any unit results in down adjustments of the corresponding quotas. For instance, the BSS may comprise a list of IMSI numbers for each particular user. A non-SIM device-unique piece of information such as a MAC address of each unit may also be used by the BSS to distinguish between different units for the same user.

Above, wireless communication service types and access types have been described as different but mappable from one to the other. It is, however, realized, that in some simpler embodiments of the present invention the mapping may in fact be one-to-one, so that the BSS 130 defines requested access rights in terms of wireless communication service types that are identical to the access types used by the gateway node 110 to distinguish between different services.

Furthermore, the present invention provides for a simple and cost-efficient way to upgrade an existing mobile communication network already comprising a gateway node 110 and a charging server 120, by adding a BSS 130 and the interface 140 according to the above and configuring the gateway node 110 and the charging server 120 to request permission to grant incoming session requests according to the above.

The interface 140 may also provide an interactive interface using which an operator of the system 100 can perform configurations, such as define packages used as described above.

Thus, the invention shall not be limited to the described embodiments, but may be varied within the scope of the enclosed claims.

1-16. (canceled)

17. Method for managing the use by a particular user of wireless communication services, which user uses a wireless communications unit (101) comprising a SIM (Subscriber Identity Module) card (102) used for identification of the unit, wherein wireless communications to and from the wireless communications unit are routed via a gateway node (110), which communicates with a charging server (120), in turn communicating with a BSS (Business Support System) (130), which gateway node categorizes different wireless communication services into a set of access types, the method comprising the steps of
a) the BSS, which provides a digital communications interface (140), accepting via said interface (140) requests from third parties regarding the granting of access to wireless communication services of specific types to the user;
b) initiating a wireless communication session between the wireless communications unit and the gateway node, pertaining to a certain one of said access types;
c) the gateway node querying the charging server regarding the availability of communication services of the said certain access type for the user of the wireless communication service;
d) translating said certain access type into a certain one of said wireless communication service types;
e) the charging server querying the BSS, regarding the availability of communication services of the said certain wireless communication service type for the user of the wireless communication unit;
f) the BSS providing to the charging server, and the charging server to the gateway node, information regarding applicable limitations of the provision of such communication services to the user based upon one or several of said requests;
g) the gateway node providing to the user access to such communication services in case they are available; and
h) the gateway node continuously providing information to the charging server, and the charging server continuously providing information to the BSS, regarding usage of communication services of the certain access type.

18. Method according to claim 17, wherein, upon the initiation of a subsequent wireless communication session between the wireless communications unit (101) and the gateway node (110), or another gateway node which is connected to the said charging server (120), pertaining to a certain respective one of said access types, and upon a query from the gateway node in question to the charging server regarding the availability of communication services of said respective access type, the charging server checks whether information regarding availability of communication services of the said respective access type is already present in the charging sever, and if such is the case the charging server responds to the gateway node in question directly, instead of querying the BSS (130).

19. Method according to claim 17, wherein a particular type of wireless communication service is associated with a particular maximum limit in terms of data quantity, session time and/or data bandwidth, and wherein said applicable limitations communicated from the BSS (130) to the gateway node (110) comprises such a maximum limit for the type of communication service in question, which applicable limitations are mapped to one or several particular of said access types.

20. Method according to claim 19, wherein, in reaction to the providing of information to the BSS (130) in step h), the BSS updates the current maximum limit for the type of wireless communication services in question, as applicable.

21. Method according to claim 17, wherein a particular type of wireless communication service is associated with a particular condition under which such communication services are to be available to the user, and wherein said applicable limitations communicated from the BSS (130) to the gateway node (110) comprises information regarding said particular condition, alternatively that the BSS determines the said applicable limitations based upon a currently prevailing condition which is compared by the BSS to the said particular condition before communicating the applicable limitations to the charging server (120).

22. Method according to claim 19, wherein the said digital communications interface (140) accepts specifications of particular maximum limits and/or particular conditions for the granting of access to said specific wireless communication services to the user.

23. Method according to claim 17, wherein the said digital communications interface (140) accepts several requests for the same type of wireless communication services, possibly from several parties, and wherein when determining the limitations communicated from the BSS (130) in step f), the BSS prioritizes requests from a first party before requests from a second party.

24. Method according to claim 17, wherein the said digital communication interface (140) furthermore presents usage information to the user, and/or accepts requests of said type also from the user.

25. Method according to claim 17, wherein said access types are each selected from the group of access types comprising communications using a particular specified port; communications pertaining to a particular specified domain or web address; streaming communications; and communications over a particular specified protocol.

26. Method according to claim 17, wherein each of said type of wireless communication services can comprise several different of said access types, and/or several identical of said access types but associated with different conditions and/or maximum limits.

27. Method according to claim 26, wherein the BSS (130) makes available predetermined packages of wireless communication service types, with associated predetermined conditions and/or maximum limits, to which a single one of said requests can collectively pertain.

28. Method according to claim 17, wherein the BSS (130) associates the user with a default access grant to wireless communications, and wherein, in step c), in case no request has been accepted by the BSS covering said access type, the information provided by the BSS in step f) comprises limitations associated with the said default access grant.

29. Method according to claim 17, wherein the BSS (130) stores historic information regarding to what party request or default access right each session pertains, and wherein the BSS makes available information based upon this historic information for billing purposes.

30. Method according to claim 17, wherein the requests can also pertain to wireless communication services provided not via the gateway node (110) but using a wireless communications network (150) not using the SIM card (102) for identification of the unit (101), wherein the BSS (130) communicates with a wireless provider of such communication services, and wherein the method comprises the additional steps of
the BSS providing to the said wireless provider information regarding applicable limitations of the provision of wireless communication services of particular types to the user of the wireless communications unit based upon one or several of said requests;
initiating a wireless communication session between the wireless communications unit and the said wireless provider
the wireless provider providing to the user access to such communication services in case they are available; and
the wireless provider providing information to the BSS regarding usage of said wireless communication services.

31. Method according to claim 30, wherein, before step f), the BSS (130) prioritizes between the gateway node (110) and the wireless network (150), so that a particular wireless communications service of a certain type is provided to the user depending on a predetermined criterion.

32. System for managing the use by a particular user of wireless communication services, which user uses a wireless communications unit (101) comprising a SIM (Subscriber Identity Module) card (102) used for identification of the unit, which system comprises a gateway node (110) and a charging server (120), wherein wireless communications to and from the wireless communications unit are routed via a gateway node (110), which is further arranged to communicate with the charging server, and which charging server in turn is arranged to communicate with a BSS (Business Support System) (130), which gateway node is further arranged to categorizes different wireless communication services into a set of access types, wherein the BSS is arranged to provide a digital communications interface (140), in turn arranged to accept requests from third parties regarding the granting of access to wireless communication services of specific types to the user, wherein, upon the initiation of a wireless communication session between the wireless communications unit and the gateway node, pertaining to a certain one of said access types, the gateway node is arranged to query the charging server regarding the availability of communication services of the said certain access type for the user of the wireless communication service, the system is arranged to translate said certain access type into a certain one of said wireless communication service types, and the charging server is arranged to thereupon query the BSS, regarding the availability of communication services of the said certain wireless communication service type for the user of the wireless communication unit, wherein the BSS is arranged to in response thereto provide to the charging server, and the charging server to the gateway node, information regarding applicable limitations of the provision of such communication services to the user based upon one or several of said requests, wherein the gateway node is arranged to then provide to the user access to such communication services in case they are available, and wherein the gateway node is arranged to thereafter continuously provide information to the charging server, and the charging server is arranged to continuously provide information to the BSS, regarding usage of communication services of the certain access type.
